(19) United States
(12) Patent Application Publication
(10) Pub. No.: US 2024/0150139 A1
(43) Pub. Date: May 9, 2024

(54) SYSTEM AND METHOD FOR IDENTIFYING OR ACQUIRING DATA CORRESPONDING TO A HANDLED ITEM

(71) Applicant: Aquabot Ltd., Afula (IL)

(72) Inventors: Yigal Natan RINGART, Givat Ela (IL); Shay GABRIELI, Ramat Yishai (IL); Tal MORENO, Kibbutz Yiftah (IL)

(73) Assignee: Aquabot Ltd., Afula (IL)

(21) Appl. No.: 18/281,338

(22) PCT Filed: Mar. 10, 2022
(86) PCT No.: PCT/IL2022/050271

§ 371 Date: Sep. 11, 2023

Related U.S. Application Data
(60) Provisional application No. 63/158,902, filed on Mar. 10, 2021.

(51) Int. Cl. B65G 61/00; G05B 19/4155

(52) U.S. Cl. CPC B65G 61/00; G05B 19/4155; B65G 2203/0216; B65G 2203/041; B65G 2203/044; G05B 2219/40269

(57) ABSTRACT

A system for identifying a handled item includes a robotic arm having a gripper configured to grip an item, transfer the item and release the item, a conveyor track to receive the item from the robotic arm and to transport the item one or a plurality of sensors to scan one or a plurality of surfaces of the item in order to detect identifiable characteristics on the one or a plurality of surfaces of the item and a processor to receive scan data from the one or a plurality of sensors and to identify the item based on the detected identifiable characteristics.

### FIELD OF THE INVENTION

The present invention relates to handling items. More particularly, the present invention relates to a system and method for identifying or acquiring data corresponding to a handled item.

### BACKGROUND OF THE INVENTION

Increasingly, items are being ordered remotely, e.g., via the internet, using smartphone applications, telephone, order management software provided by a warehouse or a logistics company or otherwise. Remote ordering allows buyers to order items from the convenience of their home, office or any other location, without having to travel to and from a store, be it a local store (e.g., same town or district) or a remote store (further part of the country or abroad). In the case of medications and other pharmaceutical products, facilitating remote ordering allows patients who are unable to travel (e.g., due to illness or other temporary or permanent disability) to obtain these products conveniently and in a timely manner. Therefore, warehouses, distribution centers, or other facilities that are tasked with fulfilling orders are required to fulfill and deliver an increasing volume of orders rapidly and accurately.

Order fulfillment facilities are aimed at promoting rapid, accurate, and efficient selection and packing of items to fulfill orders with the help of various automated systems. Automated equipment may be configured to label packages and to read labels or markings on packages. Typically, a system for reading labels, such as barcodes, may include one or a plurality of label sensors (e.g., barcode readers). One of the challenges of reading a label on a package is the position of the label on the package. A label reader typically requires clear and full vision of the label so that the sensor may successfully scan that label. However sometimes the ability to read the label depends on the position and/or orientation of the label on the item presented to the barcode reader.

It may be desirable to provide a system and method for scanning an item when handling the item, to detect identifiable characteristics so as to obtain data corresponding to a handled item or verify the item or its content.

### SUMMARY OF THE INVENTION

There is thus provided, in accordance with an embodiment of the invention, a system for identifying a handled item. The system may include a robotic arm comprising a gripper configured to grip an item, transfer the item and release the item. The system may also include a conveyor track to receive the item from the robotic arm and to transport the item. The system may also include one or a plurality of sensors to scan one or a plurality of surfaces of the item to detect identifiable characteristics of the one or a plurality of surfaces of the item. The system may also include a processor to receive scan data from the one or a plurality of sensors and identify the item based on the detected identifiable characteristics.

According to some embodiments of the invention, the processor is configured to verify the item or content of the item based on the on the detected identifiable characteristics.

According to some embodiments of the invention, the identifiable characteristics are selected from the group consisting of: a label, printed or otherwise inscribed information, text, logo, artwork, mark, shape, and visible characteristics.

According to some embodiments of the invention, the one or a plurality of sensors is selected from the group of sensors consisting of: scanning sensor, imaging sensor, camera, barcode reader, proximity sensor, rangefinder, mapping sensor, lidar, point cloud sensor and laser based sensor.

According to some embodiments of the invention, the robotic arm is configured to manipulate the item so as to allow said one or a plurality of sensors to scan the one or a plurality of surfaces from different directions of views.

According to some embodiments of the invention, the robotic arm is configured to flip the item.

According to some embodiments of the invention, the gripper is selected from the group consisting of: mechanical griper, clamp, suction cup, fixture, vacuum gripper, pneumatic gripper, hydraulic gripper, magnetic gripper, electric gripper, and electrostatic gripper

According to some embodiments of the invention, the system may also include one or a plurality of illumination sources to illuminate the item.

According to some embodiments of the invention, the one or a plurality of illumination sources is selected form the group consisting of: red or infra-red-light source, 2700 kelvin lighting, 700 nm-635 red spectrum light, 760 nm-1 mm red and infra-red wavelength spectrum light, yellow spectrum lamp, 3000 kelvin light, and 590 nm to 560 nm wavelength spectrum light.

According to some embodiments of the invention, the system is further provided with an enclosure to prevent or limit penetration of ambient light into a space within the enclosure.

According to some embodiments of the invention, a wall of the enclosure is made of opaque or shading material.

According to some embodiments of the invention, the robotic arm is configured to drop the item on the conveyor track.

According to some embodiments of the invention, there is provided a method for identifying an item. The method may include gripping an item, transferring the item and releasing the item, using a robotic arm comprising a gripper. The method may also include receiving the item from the robotic arm and transporting the item on a conveyor track. The method may also include scanning one or a plurality of surfaces of the item by one or a plurality of sensors for to detect identifiable characteristics of the one or a plurality of surfaces of the item and identify the item or a content of the item based on the detected identifiable characteristics.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 is an isometric view of the system for identifying a handled item, in accordance with some embodiments of the present invention, incorporated in a robotic arm, and gripping a package.

FIG. 2 is an isometric view of the system of FIG. 1, showing the robotic arm gripping a package under a scanning sensor with the package facing the scanning sensor.

FIG. 3 is an enlarged portion of FIG. 2, showing the robotic arm gripping the package under the scanning sensor with the package facing the scanning sensor.

FIG. 4 is an isometric view of the system of FIG. 1, showing the robotic arm gripping the package under the scanning sensor with the package now flipped (with respect to its position shown in FIG. 3) and facing a conveyor belt.

FIG. 5 is an isometric view of the system of FIG. 1, showing the package after it was dropped on the conveyor belt under the scanning sensor.

FIG. 6 is an isometric view of the system of FIG. 1, showing the package near additional scanning sensors.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In some embodiments of the present invention, a system for identifying an item may include a robotic arm that is configured to grip and manipulate an item, e.g., items that is included in an order and that is stored in any of a plurality of item storage units (such as an item dispenser or box or tray or conveyor) within a volume defined by a physical reach of the robotic arm, in which the robotic arm may operate. Each item storage unit may be configured to store one or more types of items. For example, types of product items may differ from one another by their shape, size, material, weight, exterior markings or appearance, or other characteristics of the item or of a container that contain the item. The robotic arm may be configured to reach each item in any of the plurality of item storage units.

In some embodiments of the present invention, a controller of system for identifying a handled item may be configured to control the robotic arm to sequentially collect selected items that are required to fulfill an order (e.g., received from a client, a retailer, a distributor, or other entity). The controller may be configured to cause the robotic arm to reach for, grip and convey a selected item from the storage unit in which the selected item is stored to a conveyor track, for conveying for further processing. The conveyor track may be configured to convey the selected item along the conveyor track for packaging, labeling, assembly, shipping, and various other logistic operations. For example, the conveyor track may convey the selected items to a collection container in which product items that are part of a single order may be collected, before packing them together into a package and forwarding the package.

In some embodiments of the present invention, the conveyor track may comprise a conveyor belt, a chute, a track, or other conveying arrangement that is configured to convey an item from a loading point where the item was loaded onto the conveyor, and an unloading point where the product item may be unloaded for further processing (e.g., sorting, shipping).

In some embodiments of the present invention, the robotic arm may comprise, or communicate with, one or more scanning sensors (e.g., two- or three-dimensional imaging sensor, for example, camera), barcode reader, proximity sensors, rangefinders, mapping sensors (e.g., lidar, or laser based sensors), or other sensors to identify the position of the robotic arm, the position and/or orientation of the gripper of the robotic arm, to identify the space within which the robotic arm is configured to operate, and to detect obstacles so as to facilitate, plan and perform movement/s of the robotic arm to a particular item, gripping of the item, and conveying of the item to a destination (e.g., placing it on a conveyor track).

In some embodiments of the present invention, items of a single or multiple type may be stored in a dispenser that is configured to dispense the items, one or more at a time. The robotic arm may be configured to handle an item, including gripping the dispensed item and placing the gripped item on the conveyor track, and displaying the item to one or more sensors for scanning, allowing several viewing directions the item, during the handling of the item, so as to determine what the item is and/or what the item contains.

In some embodiments, the handled item comprises a box, a package, a parcel, a container or any other packaging.

In some embodiments of the present invention, the system for identifying an item may comprise one or a plurality of sensors configured to read one or a plurality of labels attached on a surface of an item, or read information printed or otherwise inscribed on the surface, or identify other characteristic feature, such as identifying text, logo, art-work, mark, shape (including the shape of the item itself), and any other visible characteristic that may be recognizable and used to facilitate identifying the item and/or its content. According to some embodiments of the invention, the robotic arm may grip an item and manipulate the item in space so as to expose the item to the one or a plurality of sensors, allowing the sensors to read (e.g., image or scan) some or all of the external surfaces of the item (e.g., labels may be applied to different external surfaces of an item). The one or a plurality of sensors may be located at different places along the conveyor track. Each sensor of the one or a plurality of sensors may be configured to read one or more sides of the item. The one or plurality of sensors may sense or image all sides of the item. For example, combined scans from the one or plurality of sensors may be combined to generate a reading of all sides/facets of the item.

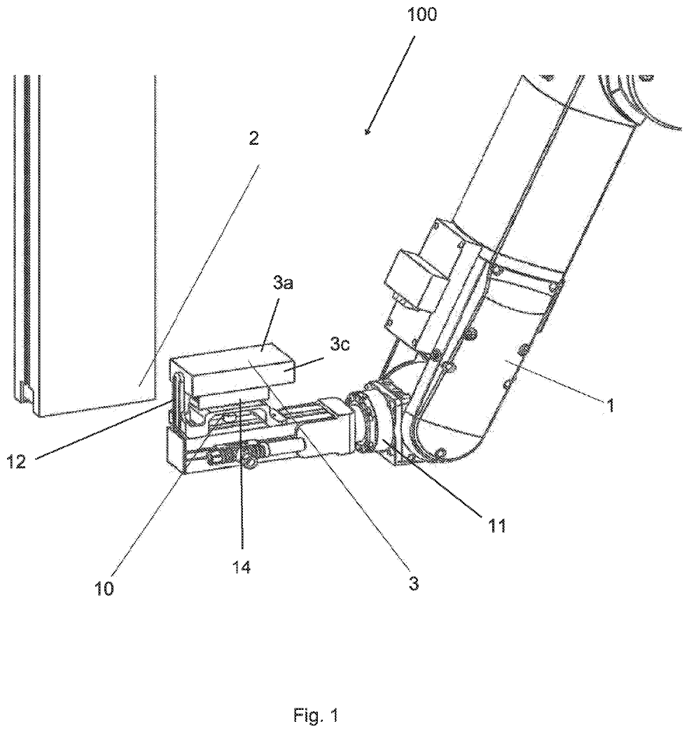

FIG. 1 is an isometric view of the system for identifying a handled item, in accordance with some embodiments of the present invention, incorporated in a robotic arm, and gripping a package.

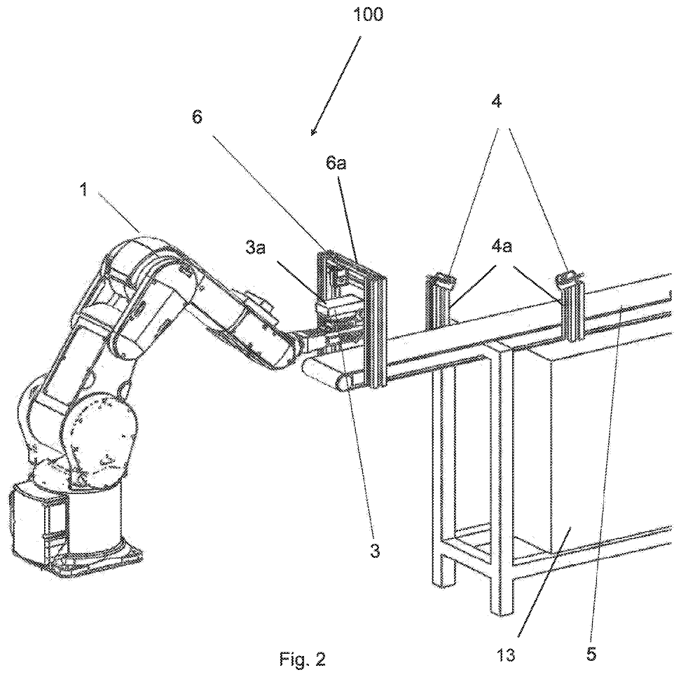

FIG. 2 is an isometric view of the system of FIG. 1, showing the robotic arm gripping a package under a scanning sensor with the package facing the scanning sensor.

In some embodiments of the present invention, a system 100 for identifying a handled item may comprise a robotic arm 1 for grabbing, manipulating and transporting an item 3, and one or a plurality of sensors (such as sensors 6 and 4) for reading, scanning or otherwise sensing identifiable visual characteristics, such as a label, marking, shape, text, logo, art-work, bar-code etc., that facilitate identifying the item and/or the content of the item 3. The robotic arm 1 may comprise one or a plurality of articulated joints. The one or a plurality of articulated joins may move and/or rotate relative to each other, facilitating movement and/or manipulation of the robotic arm 1. The articulated joints of the robotic arm 1 may enable the robot to move in space defined by the furthest reach of the robotic arm so as to grip item 3, transport item 3 to the conveyor track 5 and rotate item 3 about one or more axes (e.g., rotate item 3 adjacent with respect to a direction of view of vision sensor 6). The robotic arm may comprise an articulated robotic arm, a cartesian or rectangular robot, a polar or spherical robot, a delta or parallel robot, a cylindrical robot and similar robots configured to move in space and/or grip an item.

Processor 13 (see FIG. 2) may be provided, configured to receive scan data from the sensors and identify the item or a content of the item based on the detected identifiable characteristics. Processor 13 may further be configured to verify the item or content of the item based on the on the detected identifiable characteristics. Verifying the item or content of the item may be performed, for example by using a look-up table with information relating items and/or content of items to identifiable characteristics, by using computer vision to, by using artificial intelligence to learn items and content of items and us this knowledge to verify scanned items and/or content of scanned items.

In some embodiments of the present invention, robotic arm 1 may comprise a gripper 10 such as a mechanical griper, clamp, suction cup, fixture, vacuum gripper, pneumatic gripper, hydraulic gripper, magnetic gripper, electric gripper, electrostatic gripper or any other gripper configured to grip an item. “Grip” in the context of the present invention may include grip, grab, attach, connect, hold, or any other function for facilitating engaging with an item, picking it up, and hold it while transporting it to a desired position, and disengaging the item so it may be dropped, or otherwise placed at that position and released, or released at that position (e.g., dropped). The gripper 10 of robotic arm 1 may grip an item such as package, box, bottle, cylinder, medicine container (e.g., medicine box or tube, blister pack) or another item. The gripper 10 may be configured to grip and handle a delicate item such as a medicine box or a carton box without causing damage to the item. For example, the gripper 10 may have sensors such as a pressure sensor for sensing pressure applied by the gripper to the box and prevent the applied pressure from rising above a predetermined threshold. Gripper 10 may comprise substantially soft materials such as silicon and rubber for gripping an item without damaging the item.

Gripper 10 may comprise a mechanical gripper, e.g., an operable hand or hand-like device, include clamps or clips, one or more holders, magnet/s, electrostatic holder, etc.

In some embodiments of the present invention, the gripper 10 of the robotic arm 1 may be configured to grip item 3 while offering maximized visibility of item 3, so as to allow successful imaging or otherwise sensing characteristics of one or more surfaces of the item 3. Gripper 10 may have a suction pad 14 and a pulling finger 12 the finger 12 may have considerably small width for minimizing viewing blockage by pulling finger 12 to item 3 and maximize exposure of item 3 to the one or a plurality of sensors 4,6. It may be appreciated by a person skilled in the art that there be other grippers that facilitate grip of item 3 while maximizing exposure of item 3 to the one or plurality of sensors 4,6. For example, a gripper such as a vacuum suction cup may grip item 3 while covering a minimal surface of item 3 and little it any of a label on item 3, providing the one or a plurality of sensors with maximal field of view of item 3 and any information, labels or other visual of physical characteristics on item 3.

In some embodiments of the present invention, the robotic arm 1 may be configured to pick up, pull, grab, push and/or grip an item 3 and remove the item 3 from item dispenser 2 or box or tray or infeed conveyor. Dispenser 2_may comprise a sleeve configured to hold one or a plurality of items in a stacked configuration. The robotic arm 1 may grip an item 3 using robotic clamp 4 and extract item 3 from the item dispenser 2.

In some embodiments of the present invention, system 100 may comprise one or a plurality of storage spaces such as dispenser 2 for storing items. Each dispenser may contain unique or multiple item type. The dispenser may be configured to contain items of various shapes (e.g., tubular, rectangular, box shaped, round, concave, convex etc.). Robotic arm 1 may be configured to grip and dispense one or a plurality of items from each dispenser of system 100.

In some embodiments of the present invention, robotic arm 1 may be configured to grip item 3 and transport item 3 towards a conveyor track such as conveyor belt 5. The robotic arm 3 may grip the item 3 whilst holding item 3 facing scanning sensor 6. The scanning sensor may scan the item and identify the item and/or the content of the item based on the scan of item 3 by the scanning sensor. If item bears information on a proximal facet 3a of the item 3 facing scanning sensor 6, first sensor 6 may scan that facet 3a of the item 3 and retrieve the information, thereby facilitating identifying of the item or identifying content of item 3. To ensure successful identification, additional one or more scanning sensors 4 may be provided, for scanning one or more surfaces of the item that were hidden from scanning sensor 6 and that are revealed to the additional sensors after the item is flipped or otherwise manipulated by robotic arm 1 in space.

It is noted that while the item in the figures is depicted as a rectangular box, items handled by a system according to the present invention may have various shapes (e.g., round, oval, polygonal, etc.) and sizes.

In some embodiments of the present invention, the robotic arm 1 may be configured to flip item 3 and drop item 3 onto conveyor belt 5. Sensor 6 may then scan the distal facet 3b of the item 3 that was previously hidden from and is now facing scanning sensor 6. The item 3 may be carried along conveyor belt 5. Additional scanning sensors 4 may scan side facets 3c of the item and distal facet 3b of the item 3. The item 3 while passing on conveyor belt 5 may pass under scanning sensor 6 and additional scanning sensors 4, thereby facilitating scan by the sensors of all facets of the item 3, thus obtaining a substantially full coverage of the item.

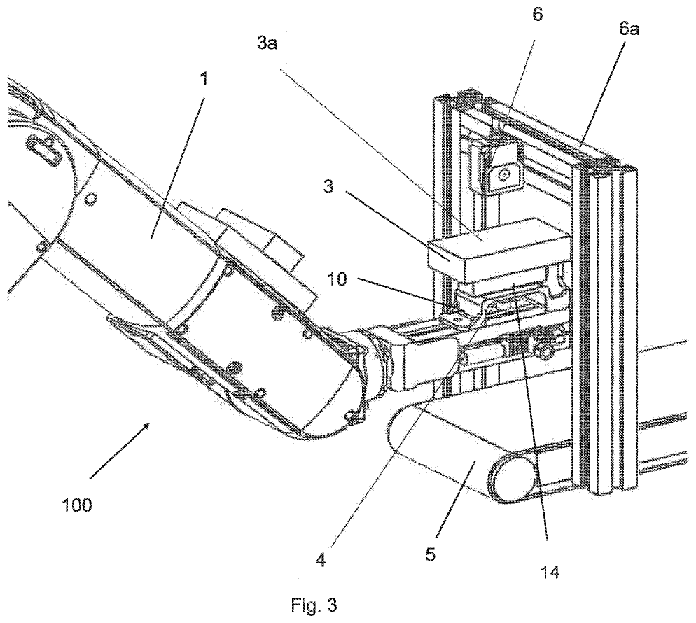

FIG. 3 is an enlarged portion of FIG. 2, showing the robotic arm gripping the package under the scanning sensor with the package facing the scanning sensor. In some embodiments of the present invention robotic arm 1 may be configured to grip item 3 and transport item 3 to a position within the field of view of scanning sensor 6. The robotic arm 1 may present the proximal facet 3a of item 3 to the scanning sensor 6 so that the scanning sensor may scan the first facet of item 3 and obtain visual characteristics of the item that appear on facet 3a or other facet of item 3 that is within the field of view of scanning sensor 6.

In some embodiments of the present invention, the robotic arm 1 may manipulate item 3 in space so that proximal facet 3a of item 3 may face scanning sensor 6. The robotic arm 1 may hold item 3 substantially still or move it at a speed that allows scanning sensor 6 to successfully scan the viewed surfaces of item 3 and retrieve the characteristics with which item 3 and/or the content of item 3 may be identified. The robotic arm 1 may transport item 3 in the direction of conveyor track 5. Scanning sensor 6 may obtain one or a plurality of scans of item 3 while item 3 is substantially immobile or moving. For example, sensor 6 may obtain one or a plurality of scans of item 3 while robotic arm 1 grips item 3 substantially immobile in the vicinity of scanning sensor 6 (e.g., allow it to scan proximal facet 3a of item 3). Scanning sensor 6 may obtain one or a plurality of scans of item 3 while item 3 is mobile. For example, sensor 3 may obtain one or a plurality of scans of item 3 while robotic arm 1 moves item 3 substantially in the vicinity of scanning sensor 6. Scanning sensor 6 may be a bar code reader, it may be required to move item 3 along first sensor 6 so that first sensor 6 may scan substantially all of the facet of item 3 facing scanning sensor 6. In another example, scanning sensor 6 may obtain one or a plurality of scans of item 3 while item 3 is on conveyor track 5 (e.g., scanning sensor 6 may scan distal facet 3b of item 3).

In some embodiments of the present invention, the one or a plurality of scanning sensors may be attached or fixed to one or more structures for holding the one or plurality of scanning sensors such as first sensor holder 6a and additional sensor holders 4a. First sensor holder 6a may comprise a rectangular structure for holding scanning sensor 6 in the vicinity of conveyor track 5. Sensor holder 6a and/or additional sensor holders 4a may be adjustable. For example, sensor holder 6a may comprise an adjustable arm configured to be adjusted by a user of system 100 for directing and manipulating scanning sensor 6 and/or adjust the direction of view and field of view of scanning sensor 6. Sensor holder 6a and/or additional sensor holders 4a may comprise a mobile structure such as a robotic holder, for manipulating and/or moving scanning sensor 6 and/or adjusting the view angle and field of view of scanning sensor 6 and of additional sensors 4.

In some embodiments of the present invention, scanning sensor 6 and/or additional sensors 4 may be connected or coupled to a controller. Scanning sensor 6 and/or additional sensors 4 may be connected or coupled wirelessly (e.g., Wi-Fi, Bluetooth, and similar wireless communication methods) or via wires to the controller. The controller may obtain sensed data and scans from the sensors. The controller may control the sensors, conveyor track and robotic arm.

In some embodiments of the present invention, scanning sensor 6 may be directed substantially vertically towards conveyor track 5. Scanning sensor 6 may be configured to sense the distal facet 3a of item 3 (e.g., when item 3 is gripped by robotic arm 1) and/or sense distal facet 3b of item 3 (e.g., when item 3 is flipped and when it is on conveyor track 5).

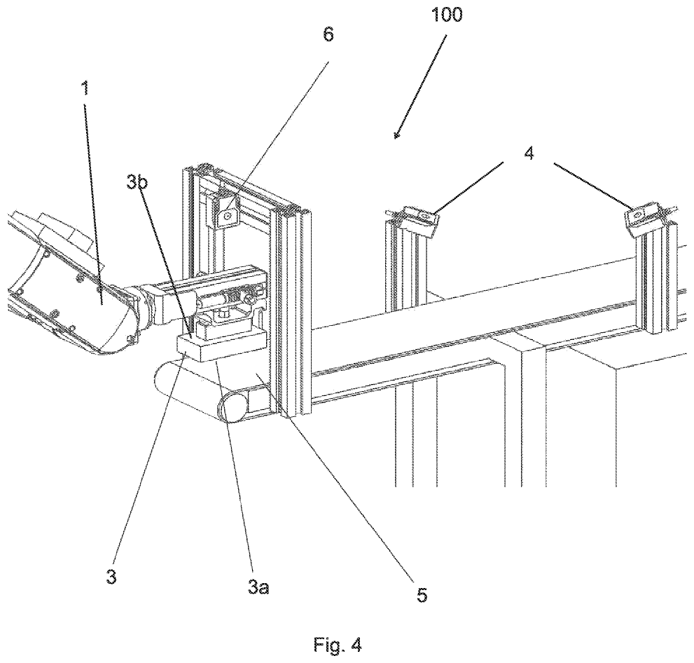

In some embodiment of the present invention, scanning sensor 6 may be enclosed in an enclosure 9 (see FIG. 4). The enclosure 9 may be configured to repel or otherwise prevent dust and contaminants from obstructing the field of view of scanning sensor 6. The enclosure 9 may be configured to reduce or prevent exposure of item 3, scanning sensor 6 and field of vision of scanning sensor 6 to ambient light outside of the enclosure to maintain optimal lighting, e.g., by providing one or a plurality of illumination sources 7 to illuminate the item 3 for successfully scanning item 3. The one or a plurality of illumination sources may provide illumination in a predetermined spectral range for providing optimal lighting for scanning item 3. For example, the enclosure may comprise one or a plurality or red or infra-red-light sources (e.g., 2700 kelvin lighting, 700 nm-635 red spectrum light and/or 760 nm-1 mm red and infra-red wavelength spectrum lighting), or yellow spectrum lamps (e.g., 3000 kelvin lighting or 590 nm to 560 nm wavelength spectrum lighting).

In some embodiments of the present invention, the sensors (such as scanning sensor 6 and additional sensors 4) may be configured to read one or a plurality of labels applied to item 3. The sensors may be configured to read a label that is applied to one or more facets of item 3. For example, the sensors may sense a label applied to proximal facet 3a and extending to side facets 3c of item 3. In another example, the sensors may sense a label wrapped around item 3 or parts of item 3. The sensors may sense visual identifiers (such as labels, barcodes, test, logos, serial numbers, logos, and other identifiable markings or physical identifying characteristics) on item 3.

FIG. 4 is an isometric view of the system of FIG. 1, showing the robotic arm gripping the item 3 (e.g., package) under the scanning sensor with the package now flipped (with respect to its position shown in FIG. 3) and facing a conveyor belt.

The robotic arm 1 may have a distal articulated joint. The articulated joint 11 may rotate the package in space so that the package is facing sensor 6 or conveyor belt 6. Robotic arm 1 may grip the package 3 so that proximal facet 3a of the package is facing sensor 6. The articulated joint 11 may rotate the package 3 so that proximal facet 3a of package 3 is facing the conveyor belt and distal facet 3b of package 3 is facing the conveyor belt. Enclosure 9 may be provided to prevent ambient light from penetrating into the internal space of enclosure 9. The walls of enclosure 9 appear transparent in this figure to allow viewing internal components, however in some embodiments of the invention the wall of enclosure 9 may be made of an opaque or shading material.

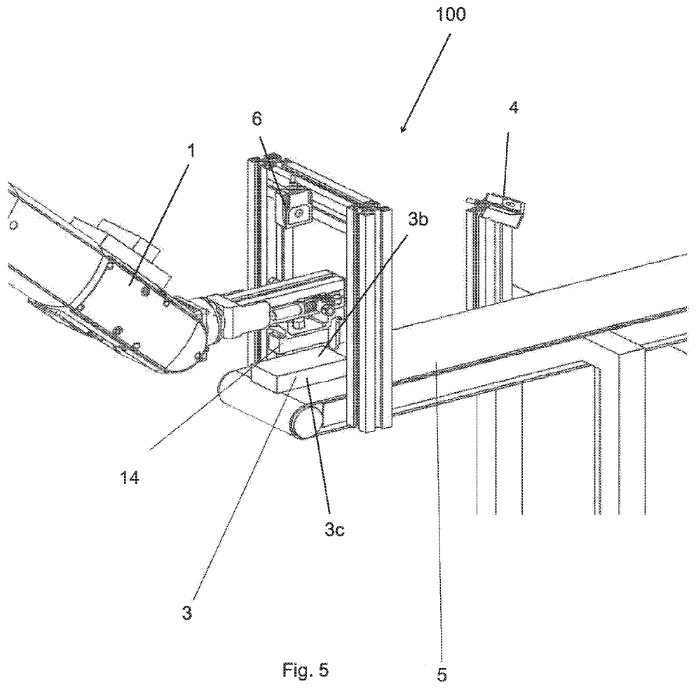

FIG. 5 is an isometric view of the system of FIG. 1, showing the package after it was dropped on the conveyor belt under the scanning sensor.

In some embodiments of the present invention, the conveyor track 5 may be configured to receive and transport one or a plurality of items along the conveyor track and into a box, or onto another track for transporting the item away for further processing. The conveyor track may comprise static and/or moving parts such as a conveyor belt, a chute, track, rolls, mechanical and electromechanical motors and/or other devices that are configured to convey an item.

In some embodiments of the present invention, robotic arm 1 may transport and/or rotate item 3 and place item 3 on conveyor track 5. Robotic arm 1 may place item 3 in the vicinity of the scanning sensor 6 (and/or additional scanning sensors 4), so that item 3 and/or distal facet/s of item 3 are placed in a field of view of scanning sensor 6 and/or additional sensors 4. The robotic arm 1 may retract from conveyor belt 5, e.g., after dropping item 3 onto conveyor belt 5 thereby exposing item 3 and distal facet 3b of item 3 to scanning sensor 6 and/or to additional sensors 4

In some embodiments of the present invention, conveyor track 5 may substantially continuously move. For example, item 3 placed on conveyor track 5 may continuously move and be transported along conveyor track 5. Scanning sensor 6 and additional sensors 4 may sense item 3 on conveyor track 5 while item 3 is in motion over the conveyor track 5.

In some embodiments of the present invention, conveyor track 5 may be configured to halt or slow down for providing optimal sensing conditions for scanning sensor 6 and additional sensors 4. Conveyor track 5 may be configured to sense when item 3 is in the vicinity of the sensors and/or in the field of view of the sensors (e.g., at one or more predetermined places along conveyor track 5). Scanning sensor 6 and additional sensors 4 may sense item 3 when conveyor track halts or slows down or when the item is conveyed at a regular speed.

In some embodiments of the present invention, robotic arm 1 may manipulate item 3 and place item 3 on conveyor belt 5 at a predetermined orientation. Robotic arm 1 may place item 3 on conveyor belt 5 so as to comply with the shape and/or size of item 3. For example, robotic arm 1 may place a rectangularly shaped box with a wider facet of the box facing the conveyor belt, the box being oriented so that an elongated axis of the box is substantially in the direction of movement of the conveyor belt. Robotic arm 1 may place item 3 on conveyor track 5 taking into consideration stability of item 3 while being transported along conveyor track 5. For example, robotic arm 1 may place item 3 such that a base of item 3 (e.g., if item 3 has a base that is wider than a body of item 3) is facing conveyor track 5. In another example, if item 3 is substantially tubular (e.g., a tubular medicine container), robotic arm 1 may place item 3 on a flat surface of item 3 (so that item 3 does not roll off the track while being transported along conveyor track 5).

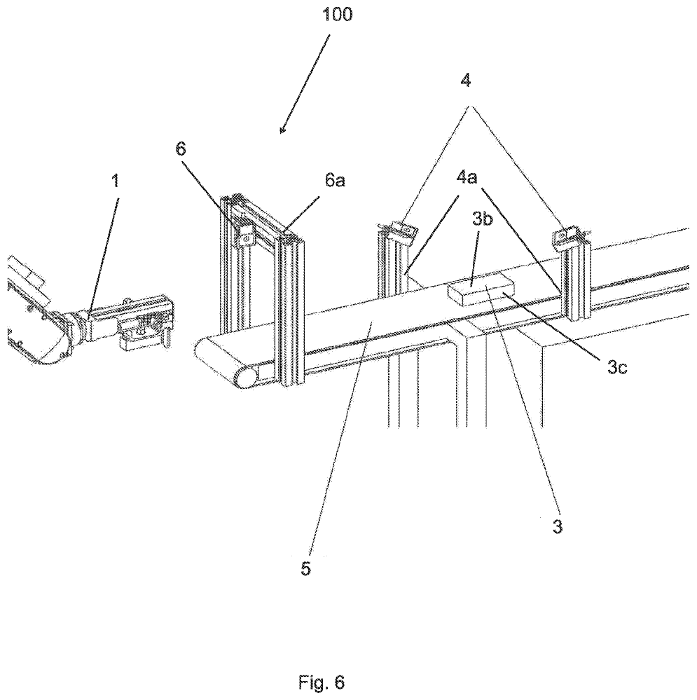

FIG. 6 is an isometric view of the system of FIG. 1, showing the package near additional scanning sensors. Conveyor track 5 may transport item 3 along conveyor track 5 while exposing item 3 and/or sides of item 3 to scanning sensor 6 and additional sensors 4. Scanning sensor 6 may be placed at or near a proximal end of conveyor track 5. Additional sensors 4 may be placed along conveyor track 5.

In some embodiments of the present invention, additional sensors 4 may be configured to scan side facets 3c of item 3. When conveyor track 5 transports item 3 so as to reach a field of vision of additional sensors 4, additional sensors 4 may image or sense item 3, distal facet of item 3 and/or side facets of item 3. Additional sensors 4 may be oriented or angled for optimizing their field of view with respect to the anticipated position and orientation of items to be conveyed over the track. Additional sensors 4 may be oriented along the direction of movement of conveyor track 5 and/or opposite to the direction of movement of conveyor track 5. Additional sensors 4 may be held by additional sensor holders 4a. Additional sensors 4 may be aimed or tilted toward predetermined parts of conveyor track 5.

In some embodiment of the present invention, additional sensors 4 may scan one or a plurality of labels on item 3. Additional sensors 4 may comprise a different type of sensor than scanning sensor 6. For example, scanning sensor 6 may comprise a camera and additional sensors 4 may comprise barcode readers. Additionally or alternatively, first scanner 6 may comprise a barcode reader and secondary scanners 4 may comprise cameras.

In some embodiment of the present invention, additional sensors 4 may be enclosed in an enclosure. The enclosure may repel dust and contaminants from additional sensors 4 and field of vision of additional sensors 4. The enclosure may limit exposure of item 3, additional sensors 4 and field of vision of additional sensors 4 from light (e.g., ambient light) outside of the enclosure for providing optimal lighting for sensing item 3 and labels on item 3. The enclosure may comprise one or a plurality of light sources with predetermined spectra for providing optimal lighting for sensing item 3.

In some embodiments of the present invention, system 100 may comprise a controller (such as a computer) configured to obtain scans of item 3 from scanning sensor 6 and additional sensors 4 and analyze said scans. The controller may comprise an algorithm for analyzing scans of the sensors. The controller may detect one or a plurality of labels on item 3 by analyzing scans from the sensors. For example, if a label is applied to more than one facet (or side) of item 3, the controller may use image processing to identify the label (and contents of the label, e.g., serial numbers and text).

In some embodiments of the present invention, the controller of system 100 may detect mislabeling of item 3 or a missing label from item 3. The controller may be configured to generate an output signal indicating mislabeling of item 3. For example, if item 3 is missing a label or is mislabeled, system 100 may be configured to discard of item 3, alert a user of item 3, and/or control robotic arm 1 for gripping an item similar to item 3.

In some embodiments of the present invention, when system 100 scanned item 3 (e.g., via scanning sensor 6 and additional sensors 4), conveyor belt 5 may transport item 3 along conveyor belt 5 for further handling (e.g., packaging, labeling, shipping).

Different embodiments are disclosed herein. Features of certain embodiments may be combined with features of other embodiments. Thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for handling an item, the system comprising:
a robotic arm comprising a gripper configured to grip an item located at one or a plurality of storage spaces, transfer the item to a destination and release the item at the destination;
a plurality of sensors to scan all facts of the item in order to detect identifiable characteristics on any of the facets of the item that facilitate identifying and verifying content of the item; and
a processor to receive scan data from the plurality of sensors and to identify and verify the content of the item based on the detected identifiable characteristics.

2. (canceled)

3. The system of claim 1, wherein the identifiable characteristics are selected from the group consisting of: a label, printed or otherwise inscribed information, text, logo, artwork, mark, shape, and visible characteristics.

4. The system of claim 1, wherein sensors of said plurality of sensors are selected from the group of sensors consisting of: scanning sensor, imaging sensor, camera, barcode reader, proximity sensor, rangefinder, mapping sensor, lidar, point cloud sensor, and laser based sensor.

5. The system of claim 1, wherein the robotic arm is configured to manipulate the item so as to allow said ene or plurality of sensors to scan the one or a plurality of surfaces from different directions of views.

6. The system of claim 5, wherein the robotic arm is configured to flip the item.

7. The system of claim 1, wherein the gripper is selected from the group consisting of: mechanical griper, clamp, suction cup, fixture, vacuum gripper, pneumatic gripper, hydraulic gripper, magnetic gripper, electric gripper, and electrostatic gripper.

8. The system of claim 1, further comprising one or a plurality of illumination sources to illuminate the item.

9. The system of claim 8, wherein said one or a plurality of illumination sources is selected form the group consisting of: red or infra-red-light source, 2700 kelvin lighting, 700 nm-635 red spectrum light, 760 nm-1 mm red and infra-red wavelength spectrum light, yellow spectrum lamp, 3000 kelvin light, and 590 nm to 560 nm wavelength spectrum light.

10. The system of claim 1, further provided with an enclosure to prevent or limit penetration of ambient light into a space within the enclosure.

11. The system of claim 10, wherein a wall of the enclosure is made of opaque or shading material.

12. The system of claim 1 wherein the robotic arm is configured to drop the item on a conveyor track at the destination.

13. A method for handling an item, the method comprising:
using a robotic arm comprising a gripper, gripping an item located at one or a plurality of storage spaces, transferring the item to a destination and releasing the item at the destination;
using a plurality of sensors scanning all facets of the item to detect identifiable characteristics on any of the facets of the item that facilitate identifying and verifying content of the item; and
using a processor, receiving scan data from the plurality of sensors and identifying and verifying the content of the item based on the detected identifiable characteristics.

14. (canceled)

15. The method of claim 13, wherein the identifiable characteristics are selected from the group consisting of: a label, printed or otherwise inscribed information, text, logo, graphic art-work, mark, shape, and visible characteristics.

16. The method of claim 13, wherein said one or a plurality of sensors is selected from the group of sensors consisting of: scanning sensor, imaging sensor, camera, barcode reader, proximity sensor, rangefinder, mapping sensor, lidar, point cloud sensor and laser based sensor.

17. The method of claim 13, comprising manipulating the item by the robotic arm so as to allow said one or a plurality of sensors to scan one or a plurality of surfaces from different directions of views.

18. The method of claim 17, comprising flipping the item by the robotic arm.

19. The method of claim 13, wherein the gripper is selected from the group consisting of: mechanical griper, clamp, suction cup, fixture, vacuum gripper, pneumatic gripper, hydraulic gripper, magnetic gripper, electric gripper, and electrostatic gripper.

20. The method of claim 13, further comprising illuminating the item by one or a plurality of illumination sources.

21-24. (canceled)
